(19) United States
(12) Patent Application Publication
(10) Pub. No.: US 2018/0138549 A1
(43) Pub. Date: May 17, 2018

(54) ELECTROLYTE FORMULATIONS FOR GRAPHENE BASED LITHIUM ION CELL ANODES

(71) Applicant: SiNode Systems, Inc., Chicago, IL (US)

(72) Inventors: Cary Michael Hayner, Chicago, IL (US); Rachid Amine, Bolingbrook, IL (US)

(21) Appl. No.: 15/349,430

(22) Filed: Nov. 11, 2016

(51) Int. Cl. H01M 10/0567; H01M 10/0525; H01M 4/134; H01M 4/133; H01M 10/0569; H01M 10/0568; H01M 4/587; H01M 4/36

(52) U.S. Cl. CPC H01M 10/0567; H01M 10/0525; H01M 4/134; H01M 4/133; H01M 2004/021; H01M 10/0568; H01M 4/587; H01M 4/364; H01M 10/0569

(57) ABSTRACT

An electrolyte of a lithium ion electrochemical cell, the electrolyte including a non-aqueous solvent, a lithium salt, and an additive. The solvent may include a solution of ethylene carbonate, diethyl carbonate, and fluoroethylene carbonate.

### TECHNICAL FIELD

Aspects of the present disclosure relate to electrochemical cells, and more particularly, to electrolyte formulations for use in lithium ion electrochemical cells having a graphene-based anode.

### BACKGROUND

Lithium (Li) ion electrochemical cells typically have a relatively high energy density and are commonly used in a variety of applications which include consumer electronics, wearable computing devices, military mobile equipment, satellite communication, spacecraft devices and electric vehicles. Lithium ion cells are particularly popular for use in large-scale energy applications such as low-emission electric vehicles, renewable power plants and stationary electric grids. Additionally, lithium ion cells are at the forefront of new generation wireless and portable communication applications. One or more lithium ion cells may be used to configure a battery that serves as the power source for these applications. The explosion in the number of higher energy demanding applications and the limitations of existing lithium ion technology are accelerating research for higher energy density, higher power density, higher-rate charge-discharge capability, and longer cycle life lithium ion cells.

Lithium-ion secondary electrochemical cells operate by a reversible exchange of lithium ions between a negative electrode, i.e., the anode and a positive electrode, i.e., the cathode. During charge, lithium ions deintercalate (or are removed from) the cathode and flow through the electrolyte to intercalate (or are inserted into) the anode. Electrons flow from a battery charger in the same direction of the flow of ions. The lithium ions remain in the anode (stores power) until electrical power is required from the battery (supplies power). Deintercalation is also defined as delithiation. Intercalation is also defined as lithiation.

During discharge, lithium ions deintercalate the anode and intercalate the cathode. It is during discharge that the lithium ion battery provides electrical power to do work (supply power). During discharge the electrons flow concurrent to the flow of ions in the electrolyte through an external circuit, i.e., through the application device requiring the electrical power. This lithium ion intercalation/deintercalation process is reversible and repeatable over multiple charge/discharge cycles.

It is known that during lithiation/delithiation, metastable phases may form within the electrodes of the battery. For example, batteries comprising silicon nanowire anodes and lithium iron phosphate (LiFePO₄) cathodes form amorphous and crystalline material phases during discharge/charge cycling that have been associated with reduced rate capability and capacity fade. Hence, not only is the anode material and structure critical, but also the mechanism of electrochemical lithiation is critical to the performance of secondary lithium ion electrochemical cells, and particularly for high energy demanding applications.

In addition, a reduction reaction initiates the formation of a passive solid-electrolyte-interphase (SEI) layer on the surface of the anode that generally comprises organic and inorganic lithium compounds. More specifically, the SEI layer is a passivation layer that forms during charge and discharge cycling of the cell in which the electrolyte undergoes a reduction reaction and adheres to the anode surface. As defined herein, a “passivation layer” is a coating which minimizes or prevents a chemical reactivity.

The formation of the SEI layer is also known to contribute to the depletion of the number of lithium ions as a portion of the lithium becomes encased within the SEI layer. This undesirable “consumption” or loss of lithium ions from the cathode active material reduces the number of lithium ions intended to achieve the capacity for which the electrochemical cell was designed. Furthermore, the SEI passivation layer hinders the intercalation of lithium ions with the anode. Thus, what results is a loss of capacity of the cathode, and ultimately, the electrochemical cell.

In addition, silicon is sometimes incorporated within a carbon based anode to increase the capacity of the anode material. Silicon has a theoretical capacity of about 4,200 mAh/g which significantly increases cell capacity when incorporated within an electrode that comprises graphite, graphene, or other carbon based active material. Examples of electrodes comprising graphene and silicon are provided in U.S. Pat. No. 8,551,650 to Kung et al. and U.S. patent application publication number 2013/0344392 to Huang et al., both of which are incorporated herein by reference.

Utilization of silicon within a carbon based anode offers the potential for a high capacity lithium alloying reaction capable of producing a lithium-rich phase (e.g. Li₁₅Si₄ and Li₂₂Si₅) in comparison to the intercalation reaction with graphite (LiC₆). However, the increased accommodation of Li⁺ ions during charge-discharge cycles induces large volume variations (as much as about 370%) and stress on a bulk anode matrix that may ultimately shorten the useful life of the anode. Furthermore, the large volume variations may cause the SEI layer to become structurally unsound such that it may break or fall off from the anode surface. If this occurs, a new SEI layer typically forms on the anode surface, thereby further depleting the available amount of lithium ions from intercalating between the anode and cathode, and further reducing the capacity of the cell.

### SUMMARY

Lithium-ion secondary electrochemical cells operate by a reversible exchange of lithium ions between a negative electrode, i.e., the anode and a positive electrode, i.e., the cathode. During charge, lithium ions deintercalate (or are removed from) the cathode and flow through the electrolyte to intercalate (or are inserted into) the anode. Electrons flow from a battery charger in the same direction of the flow of ions. The lithium ions remain in the anode (stores power) until electrical power is required from the battery (supplies power).

During the initial lithiation/delithiation cycles of a lithium-ion electrochemical cell, a metastable solid-electrolyte-interphase (SEI) layer generally forms on the surface of the anode within the battery. The SEI layer is typically composed of a combination of electrolyte components and lithium ions. Therefore, the formation of the SEI layer decreases the number of available lithium ions within the cell which generally results in capacity fade and a decrease in the rate capability of the cell. While the formation of the SEI layer is generally not desired because it results in a decrease in the number of available lithium ions within the cell, it is important to maintain the structural stability of the SEI layer such that the formation of new SEI layers is minimized. The formation of additional SEI layers further deplete the number of available lithium ions, which results in a further decrease in cell capacity.

The present application, therefore, provides for a plurality of embodiments of electrolyte formulations that minimize degradation and breakdown of the SEI layer, thus, minimizing capacity loss within the cell. According to various embodiments, provided are electrolyte formulations that comprise a solvent, an alkali metal salt, and an additive designed to retard the degradation of the solid-electrolyte-interphase (SEI) layer. Embodiments of the electrolyte formulations of the present application help to preserve the SEI layer, thereby minimizing the formation of new SEI layers that further consume lithium ions within the cell. The embodiments of the electrolyte formulations of the present application thereby permit multiple discharge and recharge cycles without significant capacity loss. In some embodiments, the electrolyte formulations comprise acid scavenger molecules that reduce the amount of certain acids in the cell that are prone to degrade the SEI layer. Other electrolyte formulations of the present application provide organic additive species that reinforce the mechanical structure of the SEI layer. In addition, the present application provides for a secondary lithium ion electrochemical cell that comprises the embodiments of the electrolytes of the present application, an anode composed of an anode active material of a material matrix comprising carbon, graphene, and a cathode comprising a lithium component.

### BRIEF DESCRIPTION OF THE DRAWINGS

FIG. 1 is a graph that illustrates percent capacity retention as a function of the number of charge/discharge cycles for lithium ion electrochemical cells comprising various embodiments of the electrolyte formulations of the present application, a first electrode comprising graphene and silicon, and a second electrode comprising lithium nickel cobalt aluminum oxide.

FIG. 2 is a graph that illustrates percent capacity retention as a function of the number of charge/discharge cycles for lithium ion electrochemical cells comprising various embodiments of the electrolyte formulations of the present application, a first electrode comprising graphene, silicon and graphite, and a second electrode comprising lithium nickel cobalt aluminum oxide.

### DETAILED DESCRIPTION

The present application discloses a plurality of embodiments of electrolyte formulations that may be used within an electrochemical cell. More specifically, the embodiments of the electrolyte formulations may be used within a secondary lithium-ion electrochemical cell comprising a first electrode or anode and a second electrode or cathode. The electrolyte formulations of the present application may be nonaqueous, ionically conductive electrolyte formulations, each of which operatively associates with the anode and the cathode of the cell. These electrolytes serve as a medium for the migration of lithium ions between the anode and the cathode during electrochemical reactions of the cell, particularly during discharge and re-charge of the cell. In various embodiments, electrolyte formulations of the present application comprise a solvent (e.g., a solvent solution or solvent mixture), an inorganic salt, and an additive. Some of the embodiments of the electrolyte formulations are comprised of an inorganic salt dissolved in a nonaqueous solvent. In addition, some electrolyte embodiments comprise an alkali metal salt dissolved in a mixture of low viscosity solvents including organic esters, ethers and dialkyl carbonates and high conductivity solvents including cyclic carbonates, cyclic esters and cyclic amides.

Embodiments of the electrolyte formulations of the present application may be designed to stabilize the formation of the solid-electrolyte-interphase (SEI) layer that forms on the surface of an anode during the initial lithiation/delithiation cycles. For example, the electrolyte formulations may be configured to protect SEI's from mechanical, thermal, and/or chemical breakdown. In some embodiments, the electrolyte formulations comprise acid scavenger molecules that react with certain acids in the cell that are prone to degrade the SEI layer. Other embodiments of electrolyte formulations of the present application provide organic additive species that reinforce the mechanical structure of the SEI layer, improve SEI formation, stabilize lithium salts, improve lithium deposition, enhance solvation, capture metal ions, provide safety protection agents, inhibit metal corrosion, protect cathode surfaces, and provide wetting agents.

As defined herein a “secondary” electrochemical cell is an electrochemical cell or battery that is rechargeable.

“Capacity” is defined herein as the maximum amount of energy, in ampere-hours (Ah), that can be extracted from a battery under certain specified conditions; the amount of electric charge that can be delivered at a rated voltage. Capacity may also be defined by the equation: capacity=energy/voltage or current (A)×time (h). “Energy” is mathematically defined by the equation: energy=capacity (Ah)×voltage (V). “Specific capacity” is defined herein as the amount of electric charge that can be delivered for a specified amount of time per unit of mass or unit of volume of active electrode material. Specific capacity may be measured in gravimetric units, for example, (A·h)/g or volumetric units, for example, (A·h)/cc. Specific capacity is defined by the mathematical equation: specific capacity (Ah/Kg)=capacity (Ah)/mass (Kg). “Rate capability” is the ability of an electrochemical cell to receive or deliver an amount of capacity or energy within a specified time period. Alternately, “rate capability” is the maximum continuous or pulsed output current a battery can provide per unit of time. Thus, an increased rate of charge delivery occurs when a cell discharges an increased amount of current per unit of time in comparison to a similarly built cell, but of a different anode and/or cathode chemistry. “C-rate” is defined herein as a measure of the rate at which a battery is discharged relative to its maximum capacity. For example, a 1C rate means that the discharge current will discharge the entire battery in 1 hour. “Power” is defined as time rate of energy transfer, measured in Watts (W). Power is the product of the voltage (V) across a battery or cell and the current (A) through the battery or cell. “C-Rate” is mathematically defined as C-Rate (inverse hours)=current (A)/capacity (Ah) or C-Rate (inverse hours)=1/discharge time (h). Power is defined by the mathematical equations: power (W)=energy (Wh)/time (h) or power (W)=current (A)×voltage (V).

In an embodiment, the solvent solution of at least one of the electrolyte formulations comprises a combination of at least a first solvent, a second solvent, and an organic compound. In an embodiment, the first solvent comprises diethyl carbonate (DEC) and the second solvent comprises fluoroethylene carbonate (FEC). The organic component preferably comprises ethylene carbonate (EC) that is dissolved in the mixture of the first and second solvents. Other first and second solvents may comprise nonaqueous solvents, organic esters, ethers, and high conductivity solvents including cyclic carbonates, cyclic esters and cyclic amides. Specific examples of first and second solvents include, but are not limited to, dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, dipropyl carbonate, and mixtures thereof. High permittivity solvents include cyclic carbonates, cyclic esters and cyclic amides such as propylene carbonate (PC), butylene carbonate, acetonitrile, dimethyl sulfoxide, dimethyl formamide, dimethyl acetamide, γ-valerolactone, γ-butyrolactone (GBL), N-methyl-2-pyrrolidone (NMP), and mixtures thereof.

In an embodiment, the first solvent, the second solvent and the organic component are mixed together to form the solvent solution in a volume ratio of 5:2:3, respectively. In an embodiment, the first solvent, second solvent or organic component may each comprise from about 5 percent to about 90 percent of the total volume of the solvent solution. The first solvent, second solvent and organic component may be combined in different volume ratio combinations that include, but are not limited to 2:5:3, 3:5:2, 5:3:2, 3:2:5 and 2:3:5. For example, a volume ratio of the first solvent to the second solvent and organic component may range from about 1:4 to about 1:1. A volume ratio of the second solvent to the first solvent and organic component may range from about 1:4 to about 1:1. A volume ratio of the organic component to the first solvent and second solvent may range from about 1:4 to about 1:1. In an embodiment, the volume ratio of the components that comprise the solvent solution are selected to balance the properties of the electrolyte.

In addition, the volume percent of a solvent solution component may be adjusted to enhance an electrochemical reaction or response. For example, ethylene carbonate (EC) is generally known to increase ionic conductivity, whereas diethyl carbonate (DEC) and fluoroethylene carbonate (FEC) are generally known to enhance SEI formation. Therefore, the volume percent of these components may be adjusted to enhance ionic conductivity or SEI formation based on a particular application and needed electrochemical performance of the resulting electrochemical cell.

In an embodiment, the salt may comprise a lithium salt. Examples of the lithium salt may include, but are not limited to, LiPF₆, LIBOB, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof. In a further embodiment, the electrolyte may comprise at least one ion-forming alkali metal salt of hexafluoroarsenate or hexafluorophosphate dissolved in a suitable solvent wherein the ion-forming alkali metal is similar to the alkali metal comprising the anode. The electrolyte may include the salt at a molarity that ranges from about 0.1 to about 1.5, with respect to the solvent solution. More preferably, the salt may be included in the solvent solution at a molarity of about 1.0.

In an embodiment, the additive may comprise at least one of a sultone, such as propene sultone (PS), a sulfite, such as ethylene sulfite (ES), a silane, such as tetravinyl methylsilane (TVMS), a lithium salt, such as LiBF₂, a phosphate such as trimethyl phosphate (TMP) or triethyl phosphate (TEP), and lithium bis(fluorosulfonyl)imide (LiFSI). In an embodiment, the additive may comprise from about 1 weight percent to about 10 weight percent of the total electrolyte formulation. More preferably, the additive comprises about 5 weight percent of the total electrolyte formulation. Table I, shown below, details the composition of some embodiments of electrolyte formulations of the present application.

TABLE I

| | Solvent | | |
|---|---|---|---|
| ID | Solution | Salt | Additive |
| 1 | EC:DEC:FEC | LiPF₆ + LiBOB | Propene Sultone (PS) |
| 2 | EC:DEC:FEC | LiPF₆ + LiBOB | Ethylene Sulfite (ES) |
| 3 | EC:DEC:FEC | LiPF₆ + LiBOB | Tetravinyl Methylsilane |
| | | | (TVMS) |
| 4 | EC:DEC:FEC | LiPF₆ + LiBOB | LiBF₂ |
| 5 | EC:DEC:FEC | LiPF₆ + LiBOB | Trimethyl Phosphate (TMP) |
| 6 | EC:DEC:FEC | LiPF₆ + LiBOB | Triethyl Phosphate (TEP) |

In addition to the electrolyte formulations, the present application provides for a lithium ion electrochemical cell in which the embodiments of the electrolyte formulation are incorporated therewithin. In an embodiment, the electrochemical cell is constructed having a first electrode or anode comprising an active electrode material that comprises a graphenic based matrix material. More specifically, the graphenic based matrix material preferably comprises a plurality of particles, each of which comprises a first active electrode material component that encapsulates an internal cargo of a second active electrode material component or plurality of components. In some embodiments, the first active material component comprises graphene, graphene oxide or a combination thereof. Herein, “graphene” may refer to graphene, graphene oxide, or reduced graphene oxide. Examples of second active electrode material component may include, but are not limited to, silicon, silicon oxide, titanium oxide, graphite, carbon, metal nanoparticles (e.g., silver or platinum), salts, such as CsCl, and combinations thereof. The particles of the active electrode material may have a structure of a variety of shapes.

More preferably, the particles of the active electrode material may have a structure that is specifically engineered to be of a substantially crumpled, paper ball-like structure, a core-shell structure, or a substantially spherical-like shape in which the graphene or graphene oxide forms an outer layer of the particle structure and silicon and/or silicon oxide is incorporated within the graphene or graphene oxide. In another embodiment, the second active material component may be interwoven or dispersed within the first active material component. Further details about the embodiments of active electrode materials and structures thereof are disclosed in U.S. Patent Application Publication Numbers 2013/0004798 and 2013/0344392, both to Huang et al., and all of which are incorporated herein by reference. These particle shapes of the active electrode material tolerate particle swelling minimizing capacity loss, particularly of the silicon or silicon oxide therein. Swelling tolerance preserves the capacity of the electrode and resulting electrochemical cell.

In addition, the outer structure of graphene, which encases the silicon, increases the electrical conductivity between the graphene and silicon. In addition, the outer graphene structure further enhances the electrical conductivity between the silicon and current collector, the supporting substrate and the surrounding area of the particles. Thus, the increased electrical conductivity provided by the outer layer of graphene, contributes to an increase in the rate capability of the resulting electrode structure and lithium ion cell. In particular, the increased electrical conductivity provided by the particle structure, particularly the outer layer of graphene, contributes to an increase in the rate capability of the resulting electrode and lithium ion cell.

In an embodiment, the active electrode material has an average particle size that ranges from about 0.5 μm to about 10 μm. In a further embodiment, the average particle size of the active electrode material ranges from about 2 μm to 5 μm. In an embodiment, the average particle size of the second active electrode component may range from about 30 nm to about 500 nm. In an embodiment, the average particle size of the second active electrode component may range from about 30 nm to about 100 nm.

Alternatively, the active electrode material may comprise a structure of a plurality of graphene sheets that are preferably arranged in a vertical stack. The vertical stack structure preferably has a continuous network of graphitic regions comprising both crystalline and non-crystalline “disordered” portions of graphene. Furthermore, the continuous network of graphitic regions is integrated with a composite comprising: (a) disordered portions of the vertical stack of graphene sheets; and (b) a second constituent, such as silicon (Si), tin (Sn), tin oxide, antimony (Sb), aluminum (Al), silver (Ag), germanium (Ge), gallium (Ga), magnesium (Mg), zinc (Zn), lead (Pb), bismuth (Bi), carbon (C), titanium oxide, lithium titanium oxide, their alloys, intermetallics, and mixtures thereof, preferably in a nano-particle form. In addition, at least some of the graphene sheets within the vertical stack may comprise defect pores formed by in-plane carbon vacancies which pre-exist or can be intentionally created. In an embodiment, at least some of the defect pores are randomly distributed throughout the graphene sheet structure. Further details about this alternative active electrode material embodiment is disclosed in U.S. Pat. Nos. 8,551,650 and 8,778,538, both to Kung et al., and all of which are incorporated herein by reference. Other suitable active electrode material compositions may include, but are not limited to, graphite, synthetic graphite, coke, fullerenes, other graphitic carbons, niobium pentoxide, tin alloys, silicon, silicon alloys, silicon-based composites, titanium oxide, tin oxide, and lithium titanium oxide.

The electrode may be constructed from an electrode slurry that comprises the active electrode material, a binder, a conductive additive, and a solvent. Appropriate proportions of the active electrode material and the other constituents are first mixed together to form the electrode slurry. Once fabricated, the electrode slurry is applied to a surface of an electrode current collector, preferably composed of an electrically conductive material, such as copper, to create an electrode for use in an electrochemical cell. After the electrode slurry has been applied to the surface of a substrate, such as a current collector, the electrode slurry is dried and calendared to compress the electrode to a desired porosity.

A dispersant (including surfactants, emulsifiers, and wetting aids), a thickening agent (including clays), defoamers and antifoamers, biocides, additional fillers, flow enhancers, stabilizers, cross-linking and curing agents may be added to the slurry mixture to ensure a homogenous mixture thereof. Examples of dispersants include, but are not limited to, glycol ethers (such as poly(ethylene oxide), block copolymers derived from ethylene oxide and propylene oxide (such as those sold under the trade name Pluronic® by BASF), acetylenic diols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes. Additional examples of dispersants may include sodium dodecanoate, alkanolamide, lanolin, polyvinylpyrrolidone, sodium alkyl sulfate, sodium alkyl sulfonate, lecithin, polyacrylate, sodium silicate, and polyethoxy, nitrocellulose and Triton® X-100 a dispersant having the chemical formula, (C₂H₄O)nC₁₄H₂₂O produced by DOW Chemical company of Midland Mich.

Examples of thickening agents include long-chain carboxylate salts (such aluminum, calcium, zinc, salts of stearates, oleats, palmitates), aluminosilicates (such as those sold under the Minex® name by Unimin Specialty Minerals and Aerosil® 9200 by Evonik Degussa), fumed silica, natural and synthetic zeolites. In an embodiment, the slurry mixture may comprise from about 0.01 to about 1.0 weight percent dispersant and/or thickening agent.

Embodiments of binders may include, but are not limited to, a fluoro-resin powder such as polytetrafluoroethylene (PTFE), polyvinylidene fluoride (PVDF), poly(acrylic) acid, polyethylenetetrafluoroethylene (ETFE), polyamides, and polyimides, and mixtures thereof. Additional binders may include, but are not limited to, polyethylene (UHMW), styrene-butadiene rubber, cellulose, polyacrylate rubber, and copolymers of acrylic acid or acrylate esters with polyhydrocarbons such as polyethylene or polypropylene, and mixtures thereof. Solvents may include, but are not limited to, deionized water, ethanol, isopropyl alcohol, ethylene glycol, ethyl acetate, polar protic solvents, polar aprotic solvents, N-methyl-2-pyrrolidone, and combinations thereof. Embodiments of conductive additives may include but are not limited to, carbon black, an electrically conductive polymer, graphite, or a metallic powder such as powdered nickel, aluminum, titanium, and stainless steel.

After the electrode slurry has been formulated, the slurry is applied to the surface of a substrate. In an embodiment, the electrode slurry may be applied to the surface of a substrate comprising a metal, a polymer, a ceramic, and combinations thereof. Non-limiting examples of substrate materials may include, but are not limited to, metals such as copper, aluminum, nickel, and their alloys, polymers such as polyethylene, polyimide, and polyether ether ketone (PEEK), as well as alumina and various glasses. In an embodiment, the electrode slurry is applied to the surface of a current collector such as those composed of copper, nickel, aluminum, and combinations thereof.

In various embodiments, the electrode slurry may be applied to a desired thickness ranging from a few nanometers to a few micrometers using a variety of non-limiting application techniques. In an embodiment, the thickness of the applied electrode slurry may range from about 5 μm to about 50 μm. These application techniques may include, but are not limited to, the use of Meyer rod coating, the use of a doctor blade or knife, spray coating, dip coating, spin coating or brush application. In addition, the electrode slurry layer may be applied to a substrate surface through the use of thick-film or thin-film processing techniques. In an embodiment, after the drying process the first active material component comprises from about 15 to about 85 weight percent, the second active material component comprises from about 15 weight percent to about 85 weight percent, and the third non-active material portion comprises from about 0.01 weight percent to about 5 weight percent of the electrode.

In some embodiments, the electrode ink is dried to a thickness ranging from about 5 μm to about 50 μm. In a further embodiment, the electrode ink is dried to a thickness ranging from about 8 μm to about 15 μm. The thickness of the dried electrode layer(s) is preferably targeted to achieve an increase in electrical power. The reduced electrode thickness minimizes the diffusion distance and which enables rapid lithium ion migration within the electrode structure.

After the slurry is dried, the formed electrode is then calendered. In some embodiments, the calendaring process compresses the electrode, thus, decreasing the void space within the dried electrode. In various embodiments, the dried electrode is calendered to achieve a target void space and internal porosity that provides for increased lithium diffusion, in addition to structural integrity. In various embodiments, the calendaring process may utilize a roller, or other such tool, that is rolled over the dried electrode to ensure a proper internal porosity. In various embodiments, the calendaring process may range from about 30 seconds to about 5 minutes depending upon the thickness of the electrode and the desired internal porosity. In some embodiments, the electrode internal porosity may range from about 40 percent to about 60 percent, more preferably, the internal porosity is about 50 percent. Internal porosity is measured by the following equation:

$$Porosity ( \% ) = 1 - ( \frac{measured density}{theoretical density} )$$

where the measured density is measured by dividing the mass of the dried electrode by its volume and the theoretical density is the density of the active electrode material that is 100 percent dense. The theoretical density is assumed to be 2.25 g/cubic centimeter. In various embodiments, constructing the electrode to a targeted optimal internal porosity provides additional channels within which lithium ions may diffuse while also providing the required structural integrity for long life in an electrochemical environment within the cell. The increased internal porosity thus provides for an increased volume of lithium ions to diffuse through the electrode. In addition, increasing the internal porosity shortens the distance with which lithium ions travel through the electrode. As a result of the increased internal porosity, the charge/discharge rate capability of the electrode and resulting electrochemical cell increases.

The electrochemical cell of the present invention further comprises a second electrode or cathode composed of an electrically conductive material that serves as the other, positive electrode of the cell. The cathode is preferably of solid materials and the electrochemical reaction at the cathode involves conversion of lithium ions that migrate back and forth between the anode, i.e., the first electrode, and the cathode, i.e., the second electrode, into atomic or molecular forms.

The solid cathode may comprise a cathode active material of a metal oxide, a lithiated metal oxide, a metal fluoride, a lithiated metal fluoride or combinations thereof as disclosed in U.S. patent application Ser. No. 14/745,747 to Hayner et al., which is assigned to the assignee of the present application and incorporated herein by reference. In an embodiment, the cathode active material comprises LiNiₓCo_{y}Al_{z}O₂, where x, y, and z are greater than 0 and wherein x+y+z=1. Other embodiments of cathode active materials may include, but are not limited to lithium cobalt oxide (LiCoO₂), lithium iron phosphate (LiFePO₄) and lithium manganese oxide (LiMn₂O₄). Additional embodiments of cathode active materials may also include, but are not limited to, LiNiₓMn_{y}Co_{z}O₂, where 0.3≤x≤1.0, 0≤y≤0.45, and 0≤z≤0.4 with x+y+z=1. Furthermore, the cathode active material may comprise Li₁₊ₓNi_{α}Mn_{β}Co_{γ}O₂, where x ranges from about 0.05 to about 0.25, α ranges from about 0.1 to about 0.4, β ranges from about 0.4 to about 0.65, and γ ranges from about 0.05 to about 0.3.

In a larger scope, the cathode active material may comprise sulfur (S), lithium sulfide (Li₂S), a lithium metal phosphate, and a lithium metal silicate where the metal may comprise a transition metal from the Periodic Table of Elements, such as iron (Fe), manganese (Mn), cobalt (Co), nickel (Ni), copper (Cu), vanadium (V), chromium (Cr), non-transition metals such as bismuth (Bi), and combinations thereof. Specific examples of cathode active materials may include MFₓ where 0≤x≤3, LiₓMFₓ where 0≤x≤3, LiMPO₄, Li₂MSiO₄ composite layered-spinel structures such as LiMn₂O₄-LIMO where M is a transition metal from the Periodic Table of Elements, such as iron (Fe), manganese (Mn), cobalt (Co), nickel (Ni), copper (Cu), vanadium (V), chromium (Cr), a non-transition metal such as bismuth (Bi), and combinations thereof. Lithium rich positive active electrode materials of particular interest can also be represented approximately by the formula Li₁₊ₓNiₐMn_{b}Co_{c}A_{d}O_{2-z}F_{Z}, where x ranges from about 0.01 to about 0.3, a ranges from about 0 to about 0.4, b ranges from about 0.2 to about 0.65, c ranges from 0 to about 0.46, d ranges from 0 to about 0.15 and Z ranges from 0 to about 0.2 with the proviso that both a and c are not zero, and where A is magnesium (Mg), strontium (Sr), barium (Ba), cadmium (Cd), zinc (Zn), aluminum (Al), gallium (Ga), boron (B), zirconium (Zr), titanium (Ti), calcium (Ca), selenium (Ce), yttrium (Y), niobium (Nb), chromium (Cr), iron (Fe), vanadium (V), lithium (Li) or combinations thereof. A person of ordinary skill in the art will recognize that additional ranges of parameter values within the explicit compositional ranges above contemplated and are within the present disclosure.

The cathode active material may be formed by the chemical addition, reaction, or otherwise intimate contact of various oxides, phosphates, sulfides and/or metal elements, preferably during thermal treatment, sol-gel formation, chemical vapor deposition, or hydrothermal synthesis in mixed states. The cathode active material thereby produced may contain metals, oxides, phosphates, and sulfides of Groups, IB, IIB, IIIB, IVB, VB, VIB, VIIB, VIII, and VIIA which includes the noble metals and/or other oxide and phosphate compounds. An embodiment of a cathode active material is a reaction product of stoichiometric proportions of at least fully lithiated to non-lithiated, LiNi_{0.8}Co_{0.15}Al_{0.05}O₂.

The exemplary cell further includes a separator to provide physical separation between the anode and cathode. The separator is formed of an electrically insulative material to prevent an internal electrical short circuit between the electrodes, and the separator material also is chemically unreactive with the anode and cathode active materials and both chemically unreactive with and insoluble in the electrolyte. In addition, the separator material has a degree of porosity sufficient to allow flow therethrough of the electrolyte during the electrochemical reaction of the cell. Illustrative separator materials include non-woven glass, polypropylene, polyethylene, microporous material, glass fiber materials, ceramics, polytetrafluoroethylene membrane commercially available under the designations ZITEX (Chemplast Inc.), polypropylene membrane, commercially available under the designation CELGARD (Celanese Plastic Company Inc.) and DEXIGLAS (C. H. Dexter, Div., Dexter Corp.).

The form of the separator typically is a sheet which is placed between the anode and cathode and in a manner preventing physical contact therebetween. Such is the case when the anode is folded in a serpentine-like structure with a plurality of cathode plates disposed intermediate the anode folds and received in a cell casing or when the electrode combination is rolled or otherwise formed into a cylindrical “jellyroll” configuration.

A form of the electrochemical cell is a lithium ion cell wherein the anode and cathode are inserted into a conductive metal casing. In an embodiment, the casing may comprise stainless steel, although titanium, mild steel, nickel, nickel-plated mild steel and aluminum are also suitable. The casing may comprise a metallic lid having a sufficient number of openings to accommodate a glass-to-metal seal/terminal pin feedthrough for the cathode and anode. An additional opening may be provided for electrolyte filling. The casing header comprises elements having compatibility with the other components of the electrochemical cell and is resistant to corrosion. The cell is thereafter filled with the electrolyte solution described hereinabove and hermetically sealed, such as by close-welding a stainless steel plug over the fill hole, but not limited thereto. The cell of the present invention can also be constructed in a case-positive design.

The glass-to-metal seal preferably comprises a corrosion resistant glass having from between about 0% to about 50% by weight silica such as CABAL 12, TA 23 or FUSITE MSG-12, FUSITE A-485, FUSITE 425 or FUSITE 435. The positive terminal pin feedthrough preferably comprises titanium although molybdenum and aluminum can also be used. The cell header comprises elements having compatibility with the other components of the electrochemical cell and is resistant to corrosion. The cell is thereafter filled with the electrolyte described hereinabove and hermetically sealed such as by close-welding a stainless steel ball over the fill hole, but not limited thereto. When the ionically conductive electrolyte becomes operatively associated with the anode and the cathode of the cell, an electrical potential difference is developed between terminals operatively connected to the anode and the cathode. During discharge, lithium ions migrate from the anode, i.e., the negative electrode to the cathode, i.e., the positive electrode. During recharge, lithium ions migrate in the opposite direction from the cathode to the anode. Migration of the lithium ions between the anode and cathode preferably occurs in atomic or molecular forms.

In an embodiment the passivation layers of the SEI may further be stabilized by subjecting the cell to a conditioning protocol. A cell conditioning protocol is a process in which an electrochemical cell, i.e. a lithium-ion cell, is subjected to a partial charge and/or discharge for a period of time. In addition, a cell may also be subjected to different temperatures during this partial charge/discharge process. The conditioning protocol is designed to encourage the formation of a stable passivation layer, i.e., the solid-electrolyte-interphase layer, thereby minimizing further consumption of lithium ions. Each conditioning protocol is specifically designed for a cell's chemical composition.

Furthermore, the conditioning protocol may improve cycling of the cell. The formation of the stable passivation layer generally increases the stability of the electrode structure and thus, results in improved management of the charge-discharge cycle. Often, during the first charge when the SEI layer is initially formed, it has been shown that it is beneficial to hold the cell in a charged or partially-charged state for a period of time in order to form a more stable and resilient layer that prevents continuous consumption of Li ions and promotes improved cycle life.

A first set of sample lithium-ion cells were constructed comprising various embodiments of the electrolyte formulations of the present application. The lithium ion cells of the first set were constructed with an anode composed of an active electrode material comprising a plurality of particulates, each particle comprising silicon encapsulated in graphene. In an embodiment, the particulates of the active electrode material comprised a particle size distribution ranging from about 0.5 μm to about 10 μm. The cathodes of each of the first set of lithium ion cells comprised lithium nickel cobalt aluminum oxide.

Three first set lithium ion cells were constructed and tested for each of the control and four test electrolyte formulations listed in Table II below.

TABLE II

| Electrolyte | Solvent | Salt | Additive |
|---|---|---|---|
| Formulation | (Volume Ratio) | Combination | (Weight %) |
| Comparative | EC:DMC:FEC | 1.2M LiPF₆ | — |
| Example | (3:5:2) | | |
| 1 | EC:DEC:FEC | 0.5M LiPF₆ + | ES (5%) |
| | (3:5:2) | 0.5M LiBOB | |
| 2 | EC:DEC:FEC | 0.5M LiPF₆ + | TVMS (5%) |
| | (3:5:2) | 0.5M LiBOB | |
| 3 | EC:DEC:FEC | 0.5M LiPF₆ + | LiBF2 (5%) |
| | (3:5:2) | 0.5M LiBOB | |
| 4 | EC:DEC:FEC | 0.5M LiPF₆ + | TEP (5%) |
| | (3:5:2) | 0.5M LiBOB | |

All first set test and control cells were subjected to a pulse discharge regimen to test the specific capacity of the respective cells. Prior to the testing, each of the cells were subjected to a conditioning regimen in which the cells were subjected to a sequence of 0.05C, 0.1C, and 0.2C current rate charge/discharge cycles.

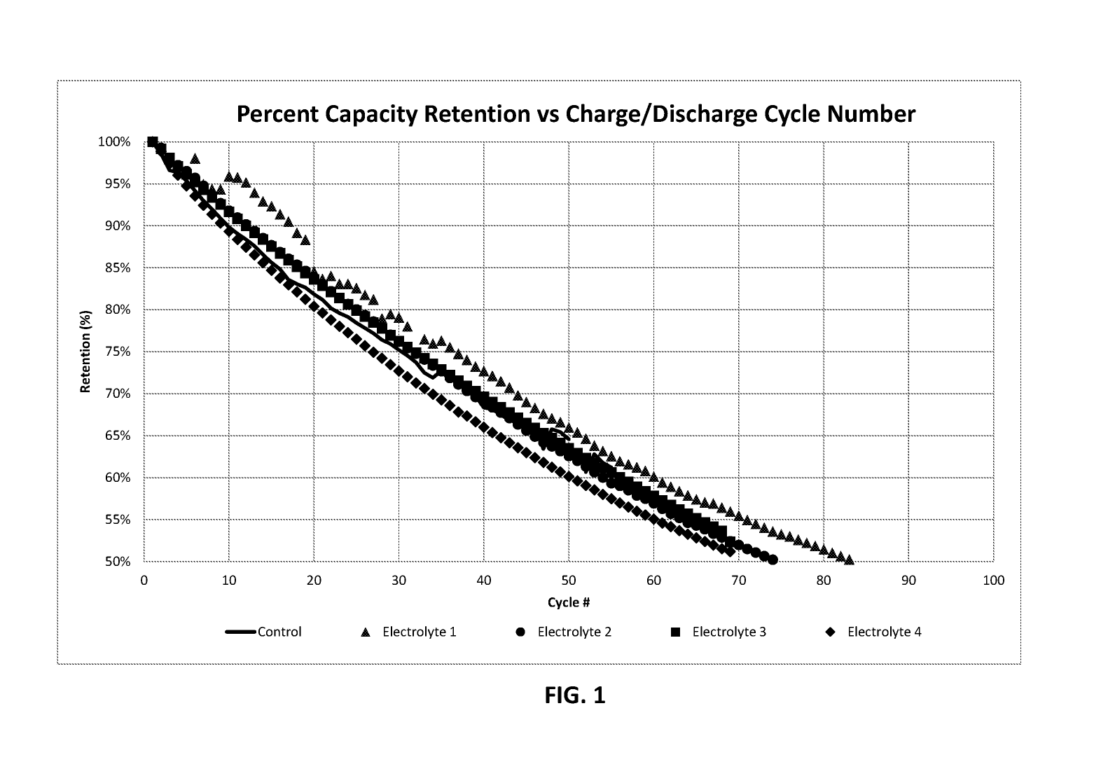

After the cells were conditioned, the cells were subjected to a 0.5C charge/discharge protocol until each of the cells reached about 50% of the initial capacity of the anode. FIG. 1 illustrates the results of the 0.5C charge/discharge testing. As shown, FIG. 1 is a graph plotting capacity retention, as a percentage of the initial capacity of the anode, after the conditioning regimen as a function of the number of 0.5C charge discharge cycles. As illustrated, the test cells constructed with electrolyte formulation 1, comprising 5 weight percent ethylene sulfite, retained the greatest percentage of capacity, about 50%, after about 82 charge/discharge cycles. In addition, the test cells constructed with electrolyte formulation 1 showed an improvement in capacity retention over the span of charge/discharge cycles in comparison to cells constructed with the control and the other three electrolyte formulations. In particular, cells constructed with the electrolyte formulation 1 exhibited an improvement of about 15% in cycle life and an improvement of about 6 percent in Coulombic efficiency in comparison to cells constructed with the control electrolyte formulation of 1.2M LiPF₆ in EC:DMC with a solvent weight ratio of 3:7 and including 20 weight percent FEC, based on the total weight of the electrolyte. Table III, shown below, illustrates the test results of the 0.5C charge/discharge cycling showing the number of charge/discharge cycles to 70 percent of the initial capacity, the percent change in capacity retention in comparison to the control electrolyte, the Coulombic efficiency of the cells, and the percent change in the Coulombic efficiency in comparison to the control cells. As defined herein “Coulombic efficiency” is the ratio of the output of charge by a battery to the input of charge.

TABLE III

| | Number | | | Change |
|---|---|---|---|---|
| | Charge/Discharge | Change in | | in |
| | Cycles to 70% | Capacity | Coulombic | Coulombic |
| | of Initial | Retention | Efficiency | Efficiency |
| Electrolyte | Capacity | (Percent) | Percent | (Percent) |
| Comparative | 39 | N/A | 65.3 | N/A |
| Example | | | | |
| 1 | 45 | 15% | 69.0 | 6% |
| 2 | 39 | 0% | 71.1 | 9% |
| 3 | 39 | 0% | 70.2 | 7% |
| 4 | 34 | −13% | 59.3 | −9% |

As detailed in Table III above, test cells comprising electrolyte formulations 1, 2, and 3 exhibited an increase in Coulombic efficiency in comparison to the control cells that comprised the control electrolyte formulation. The test cells comprising electrolyte formulation 2 exhibited the greatest increase in Coulombic efficiency of about 9 percent in comparison to the control cells. In addition, test cells comprising electrolyte formulation 1 exhibited the greatest increase in capacity retention, of about 15%, in comparison to the control cells. These test results would seem to indicate that electrolyte formulations 1, 2, and 3 of the present application, resulted in an improvement in Coulombic efficiency in comparison to the control samples. In particular, electrolyte formulation 1, which comprised 5 weight percent ethylene sulfite (ES), exhibited the greatest increase in capacity retention after the most charge/discharge cycles when incorporated within a lithium ion cell.

An additional second set of sample lithium-ion cells were constructed with the embodiments of the electrolyte formulations of the present application. The lithium ion test cells were constructed having an anode composed of a combination of first and second active electrode materials. The first active electrode material comprised particulates of silicon encapsulated in graphene having a particle size distribution ranging from about 1 μm to about 10 μm. The second active electrode material comprised graphite. Each anode was constructed with a mixture of first and second active materials of about 25 weight percent first active electrode material and 75 weight percent second active electrode material. The cathodes of each of the test and control cells were composed of lithium nickel cobalt aluminum oxide.

The second set of cells consisted of three lithium ion cells which were constructed and tested for each of the following electrolyte formulations listed in Table IV below.

TABLE IV

| | Solvent | | |
|---|---|---|---|
| Electrolyte | solution | Salt | Additive |
| Formulation | (Volume Ratio) | Combination | (Weight %) |
| Comparative | EC:DMC:FEC | 1.2M LiPF₆ | — |
| Example | (3:5:2) | | |
| 1 | EC:DEC:FEC | 0.5M LiPF₆ + | ES (5%) |
| | (3:5:2) | 0.5M LiBOB | |
| 2 | EC:DEC:FEC | 0.5M LiPF₆ + | TVMS (5%) |
| | (3:5:2) | 0.5M LiBOB | |
| 3 | EC:DEC:FEC | 0.5M LiPF₆ + | LiBF₂ (5%) |
| | (3:5:2) | 0.5M LiBOB | |
| 4 | EC:DEC:FEC | 0.5M LiPF₆ + | TEP (5%) |
| | (3:5:2) | 0.5M LiBOB | |

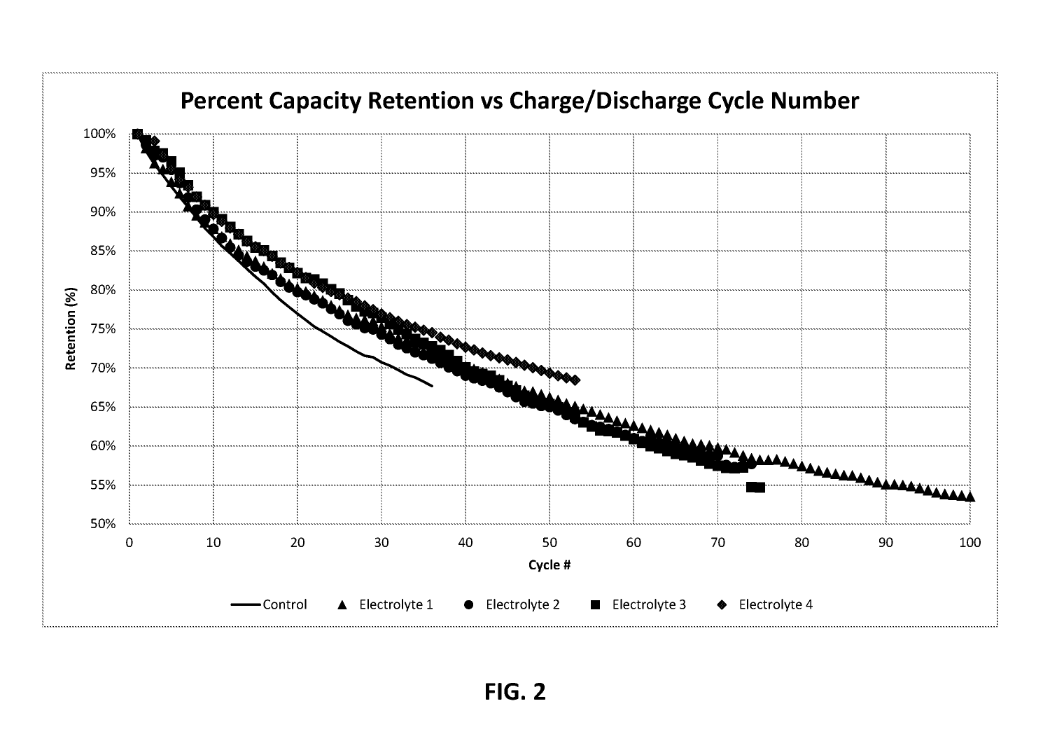

All second set test and control cells were subjected to a discharge regimen to test the specific capacity of the respective cells. Prior to the testing, each of the second set cells were subjected to a conditioning regimen in which the cells where subjected to a sequence of 0.05C, 0.1C, and 0.2C current rate charge/discharge cycles. After the cells were conditioned, the cells were subjected to a 0.5C current rate charge/discharge protocol until each of the cells reached about 50% of their initial capacity, respectively. FIG. 2 illustrates the results of the 0.5C charge/discharge testing. More specifically, FIG. 2 is a graph that plots capacity retention, as a percentage of the initial capacity of the anode, after the conditioning regimen as a function of the number of charge/discharge cycles for the tested second set cells.

As illustrated, the test cells comprising electrolyte formulation 4 having 5 weight percent TEP, retained the greatest percentage of its initial capacity, about 70%, after 50 charge discharge cycles. In addition, the test cells that comprised electrolyte 1 exhibited the greatest capacity retention of about 54% after 100 charge discharge cycles. Table V, shown below, illustrates the test results of the 0.5C charge/discharge cycling showing the number of charge/discharge cycles to 70 percent of the initial capacity, the percent change in capacity retention in comparison to the control electrolyte, the Coulombic efficiency of the cells and the percent change in the Coulombic efficiency in comparison to the control cells.

TABLE V

| | Number | Change in | | Change in |
|---|---|---|---|---|
| | Charge/Discharge | Capacity | Coulombic | Coulombic |
| | Cycles to 70% of | Retention | Efficiency | Efficiency |
| Electrolyte | Initial Capacity | (Percent) | Percent | (Percent) |
| Comparative | 31 | N/A | 75.2 | N/A |
| Example | | | | |
| 1 | 41 | 32% | 79.5 | 6% |
| 2 | 39 | 26% | 80.6 | 7% |
| 3 | 41 | 32% | 80.3 | 7% |
| 4 | 49 | 58% | 79.8 | 6% |

As detailed in the table above, second set test cells comprising electrolyte formulation 4 exhibited the greatest increase in the capacity retention of about 58% in comparison to the test cells that comprised the control electrolyte formulation. In addition, the test cells comprising electrolyte formulations 1 and 4 exhibited an increase in Coulombic efficiency of 6% in comparison to the control cells. Test cells comprising electrolyte formulations 2 and 3, exhibited an increase in Coulombic efficiency of 7% in comparison to the control cells. These test results would seem to indicate that the embodiments of the electrolyte formulations of the present application increase capacity retention and improve Coulombic efficiency.

Thus, the results of the discharge regimen show the significance of the various electrolyte formulations in increasing Coulombic efficiency and capacity retention. It is appreciated that various modifications to the inventive concepts described herein may be apparent to those of ordinary skill in the art without departing from the spirit and scope of the present invention as defined by the appended claims.

What is claimed is:

1. An electrochemical cell, comprising:
a negative electrode comprising a first component comprising graphene, graphene oxide, reduced graphene oxide, or a combination thereof, and a second component different than the first component;
a positive electrode comprising lithium; and
an ionically conductive electrolyte in which the negative and positive electrodes are immersed, the electrolyte comprising a solvent, a salt comprising an alkali metal, and an electrolyte additive configured to stabilize a solid electrolyte interphase layer that forms on a surface of the negative electrode.

2. The electrochemical cell of claim 1, wherein the solvent comprises a solution comprising at least two of ethylene carbonate, diethyl carbonate, and fluoroethylene carbonate.

3. The electrochemical cell of claim 2, wherein the solvent solution comprises ethylene carbonate, diethyl carbonate, and fluoroethylene carbonate in a volume ratio of 3:5:2, 2:5:3, 5:2:3, 5:3:2, 3:2:5, or 2:3:5.

4. The electrochemical cell of claim 2, wherein the solvent solution comprises ethylene carbonate, diethyl carbonate, and fluoroethylene carbonate, each of which comprising from about 5 percent to about 90 volume percent, based on the total volume of the solvent solution.

5. The electrochemical cell of claim 1, wherein the electrolyte additive is selected from the group consisting of propene sultone (PS), ethylene sulfite (ES), tetravinyl methylsilane (TVMS), LiBF₂, trimethyl phosphate (TMP), triethyl phosphate (TEP), and lithium bis(fluorosulfonyl)imide (LiFSI), and combinations thereof.

6. The electrochemical cell of claim 5, wherein the electrolyte additive comprises from about 1 wt % to about 10 wt % of the electrolyte, based on the total weight of the electrolyte.

7. The electrochemical cell of claim 1, wherein the salt is selected from the group consisting of LiPF₆, LIBOB, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof.

8. The electrochemical cell of claim 1, wherein a molarity of the salt in the solvent solution ranges from about 0.1 to about 1.5.

9. The electrochemical cell of claim 1, wherein:
the negative electrode comprises particles comprising the second component encapsulated by the first component; and
the negative electrode has an average particle size that ranges from about 0.5 μm to about 10 μm.

10. The electrochemical cell of claim 1, wherein the second component is selected from the group consisting of silicon, silicon oxide, tin, tin oxide, antimony, aluminum, silver, germanium, gallium, magnesium, zinc, lead, bismuth, carbon, titanium oxide, lithium titanium oxide, alloys thereof, intermetallics thereof, and mixtures thereof.

11. The electrochemical cell of claim 2, wherein:
the negative electrode is graphite free;
the second component comprises silicon particles encapsulated by the first component; and
the additive comprises ethylene sulfite (ES).

12. The electrochemical cell of claim 10, wherein the second component has an average particle size that ranges from about 30 nm to about 500 nm.

13. The electrochemical cell of claim 2, wherein:
the second component comprises silicon particles encapsulated by the first component;
the negative electrode further comprises graphite; and
the additive comprises triethyl phosphate (TEP).

14. The electrochemical cell of claim 1, wherein:
the negative electrode comprises from about 15 weight percent to about 85 weight percent of the first component, based on the total weight of the negative electrode; and
the negative electrode comprises from about 15 weight percent to about 85 weight percent of the second component, based on the total weight of the negative electrode.

15. The electrochemical cell of claim 1, wherein the negative electrode comprises from about 0.01 weight percent to about 5 weight percent of a non-active carbon material, based on the total weight of the negative electrode.

16. An electrolyte for a lithium ion electrochemical cell, the electrolyte comprising:
a solvent solution comprising ethylene carbonate, diethyl carbonate, and fluoroethylene carbonate;
a salt comprising alkali metal; and
an electrolyte additive configured to stabilize a solid electrolyte interphase layer that forms on a surface of a negative electrode of the electrochemical cell.

17. The electrolyte of claim 16, wherein the solvent solution comprises the ethylene carbonate, diethyl carbonate, and fluoroethylene carbonate in a volume ratio of 3:5:2, 2:5:3, 5:2:3, 5:3:2, 3:2:5 or 2:3:5.

18. The electrolyte of claim 16, wherein the electrolyte additive is selected from the group consisting of propene sultone (PS), ethylene sulfite (ES), tetravinyl methylsilane (TVMS), LiBF₂, trimethyl phosphate (TMP), triethyl phosphate (TEP), and lithium bis (fluorosulfonyl) imide (LiFSI), and combinations thereof.

19. The electrolyte of claim 16, wherein the electrolyte comprises from about 1 wt % to about 10 wt % of the electrolyte additive, based on the total weight of the electrolyte.

20. The electrolyte of claim 16, wherein the salt is selected from the group consisting of LiPF₆, LIBOB, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof.

21. The electrolyte of claim 16, wherein a molarity of the salt in the solvent solution ranges from about 0.1 to about 1.5.
